(19) United States
(12) Patent Application Publication
(10) Pub. No.: US 2021/0138580 A1
(43) Pub. Date: May 13, 2021

(54) ILLUMINATING APPARATUS

(71) Applicant: DISCO CORPORATION, Tokyo (JP)

(72) Inventor: Keiji NOMARU, Tokyo (JP)

(21) Appl. No.: 17/087,770

(22) Filed: Nov. 3, 2020

(30) Foreign Application Priority Data
Nov. 11, 2019 (JP) 2019-203879

(51) Int. Cl. B23K 26/06; B23K 26/08; B23K 26/046; B23K 26/03; G02B 7/36; H04N 5/232

(52) U.S. Cl. CPC B23K 26/0648; B23K 26/0853; H04N 5/23212; B23K 26/032; G02B 7/36; B23K 26/046

(57) ABSTRACT

An illuminating apparatus adapted to be mounted on an image capturing apparatus for capturing an image of a workpiece held on a chuck table includes a light source, an objective lens having a minute hole defined centrally therein and disposed in facing relation to the workpiece held on the chuck table, and an optical fiber having an end inserted in the minute hole in the objective lens and another end optically coupled to the light source.

### BACKGROUND OF THE INVENTION

### Field of the Invention

The present invention relates to an illuminating apparatus adapted to be mounted on an image capturing apparatus that includes a chuck table for holding a workpiece thereon and an image capturing unit for capturing an image of the workpiece held on the chuck table.

### Description of the Related Art

Wafers with a plurality of devices such as integrated circuits (ICs) and large scale integration (LSI) circuits formed in respective areas that are demarcated on each face side thereof by a plurality of intersecting projected dicing lines are divided by a dicing apparatus or a laser processing apparatus into individual device chips which will be used in electric appliances such as mobile phones and personal computers.

Such a dicing apparatus and a laser processing apparatus incorporate an image capturing apparatus having an automatic focusing function to capture an image of a wafer and detect a region thereof that is to be processed (see, for example, Japanese Patent Laid-open No. Sho 61-198204).

According to the technology disclosed in Japanese Patent Laid-open No. Sho 61-198204, while an image capturing unit included in the image capturing apparatus is moving at predetermined pitches with respect to a workpiece, i.e., a wafer, the image capturing unit captures images of the workpiece at the respective pitches, and the captured images are stored as image information in a control unit. The control unit then determines differential values of sampled points that are included in the captured regions of the images corresponding to the pitches, and decides that the position of the image capturing unit where the image with the largest differential value is obtained represents a focused position, i.e., a just focused position.

### SUMMARY OF THE INVENTION

Heretofore, it has been customary to radiate light radially and inwardly from a plurality of light sources disposed around a lens of the image capturing unit that faces the workpiece, to make the captured regions of images bright uniformly in their entirety. However, the light thus applied from the light sources to the wafer is scattered and overlapped, tending to make image contrast unclear even in a focused position. Thus, it is difficult to achieve a just focused position.

It is therefore an object of the present invention to provide an illuminating apparatus adapted to be mounted on an image capturing apparatus for making image contrast clear to achieve a just focused position.

In accordance with an aspect of the present invention, there is provided an illuminating apparatus adapted to be mounted on an image capturing apparatus for capturing an image of a workpiece held on a chuck table, including a light source, an objective lens having a minute hole defined centrally therein and disposed in facing relation to the workpiece held on the chuck table, and an optical fiber having an end inserted in the minute hole in the objective lens and another end optically coupled to the light source.

Preferably, the light source includes a superluminescent diode (SLD) light source, an amplified spontaneous emission (ASE) light source, a super continuum light source, a light emitting diode (LED) light source, a halogen light source, a xenon light source, a mercury light source, a metal halide light source, or a laser light source.

According to the present invention, since conically shaped light is applied to the workpiece from the end, as a point light source, of the optical fiber that is disposed in the minute hole defined centrally in the objective lens that faces the workpiece, no light is overlapped in the captured region of the image and image contrast in the captured image is sharp, thereby allowing the image capturing apparatus to be positioned in a just focused position.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a perspective view of a laser processing apparatus incorporating an image capturing apparatus on which an illuminating apparatus according to an embodiment of the present invention is mounted;

FIG. 2 is an enlarged perspective view of the image capturing apparatus illustrated in FIG. 1; and

FIG. 3 is a side elevational view, partly in cross section, illustrating the structure of the image capturing apparatus illustrated in FIG. 2.

### DETAILED DESCRIPTION OF THE PREFERRED EMBODIMENT

An illuminating apparatus according to an embodiment of the present invention will hereinafter be described in detail with reference to the drawings. FIG. 1 illustrates, in perspective, a laser processing apparatus 1 including an illuminating apparatus, denoted by 70, according to the present embodiment. As illustrated in FIG. 1, the laser processing apparatus 1 has an image capturing apparatus 50 including a holding unit 20 for holding a workpiece thereon and an image capturing unit 60 for capturing an image of the workpiece held on the holding unit 20, a moving mechanism 30 for moving the holding unit 20, and a laser beam applying unit 40 for applying a laser beam to the workpiece held on the holding unit 20.

The holding unit 20 includes a rectangular X-axis movable plate 21 movably placed on a base table 2 for movement in X-axis directions indicated by an arrow X, a rectangular Y-axis movable plate 22 movably placed on the X-axis movable plate 21 for movement in Y-axis directions indicated by an arrow Y, a hollow cylindrical post 23 fixed to an upper surface of the Y-axis movable plate 22, and a rectangular cover plate 26 fixed to the upper end of the post 23. A circular chuck table 25 is mounted on the cover plate 26 and extends upwardly through an oblong hole defined in the cover plate 26. The chuck table 25 is rotatable about its own axis by a rotating mechanism, not illustrated. The chuck table 25 has an upper surface acting as an air-permeable holding surface made of a porous material and connected to suction means, not illustrated, through a fluid channel extending through the post 23. A plurality of clamps 27 (see also FIG. 2) for fixing an annular frame F that supports the workpiece through a protective tape T are mounted on the chuck table 25. According to the present embodiment, as illustrated in FIG. 2, the workpiece is in the form of a wafer 10 having a plurality of devices 12 formed in respective areas demarcated on a face side 10a thereof by a plurality of intersecting projected dicing lines 14.

As illustrated in FIG. 1, the moving mechanism 30 is disposed on the base table 2 and includes an X-axis feed mechanism 31 for processing-feeding the holding unit 20 in the X-axis directions and a Y-axis feed mechanism 32 for indexing-feeding the Y-axis movable plate 22 in the Y-axis directions. The X-axis feed mechanism 31 converts rotary motion of a stepping motor 33 to linear motion through a ball screw 34 and transmits the linear motion to the X-axis movable plate 21, moving the X-axis movable plate 21 in one of the X-axis directions or the other along a pair of guide rails 2a mounted on the base table 2. The Y-axis feed mechanism 32 converts rotary motion of a stepping motor 35 to linear motion through a ball screw 36 and transmits the linear motion to the Y-axis movable plate 22, moving the Y-axis movable plate 22 in one of the Y-axis directions or the other along a pair of guide rails 21a mounted on the X-axis movable plate 21. Although not illustrated, position detecting means is disposed respectively on the X-axis feed mechanism 31, the Y-axis feed mechanism 32, and the chuck table 25. The position detecting means accurately detects a position of the chuck table 25 in the X-axis directions, a position of the chuck table 25 in the Y-axis directions, and an angular position of the chuck table 25 about its central axis, and sends the detected positions to a control unit 100 (see FIGS. 2 and 3) to be described later. The X-axis feed mechanism 31, the Y-axis feed mechanism 32, and the rotating mechanism of the chuck table 25 are actuated, on the basis of command signals from the control unit 100, to position the chuck table 25 in a desired coordinate position in the X-axis and Y-axis directions and a desired angular position.

A frame body 4 is erected on the base table 2 laterally with respect of the moving mechanism 30. The frame body 4 includes a vertical wall 4a disposed on the base table 2 and a horizontal wall 4b extending horizontally from the upper end of the vertical wall 4a. The horizontal wall 4b of the frame body 4 houses an optical system, not illustrated, of the laser beam applying unit 40. The laser beam applying unit 40 includes a beam condenser 42 disposed on the lower surface of a distal end portion of the horizontal wall 4b. The beam condenser 42 houses a condensing lens, not illustrated, etc., therein. The laser beam applying unit 40 also includes a laser oscillator, not illustrated, that emits a laser beam that is converged by the condensing lens of the beam condenser 42 onto a predetermined position on the workpiece held on the holding unit 20.

The image capturing unit 60 of the image capturing apparatus 50 that also includes the holding unit 20, and the illuminating apparatus 70 that is mounted on the image capturing apparatus 50 will hereinafter be described with reference to FIGS. 2 and 3. FIG. 2 illustrates, in perspective at an enlarged scale, the image capturing apparatus 50 that includes the holding unit 20 and the image capturing unit 60 for capturing an image of the wafer 10 held on the holding unit 20. FIG. 3 illustrates, in side elevation partly in cross section, specific structural details of the image capturing apparatus 50 illustrated in FIG. 2.

The image capturing unit 60 includes an objective lens casing 62, a camera 64 for capturing an image of the face side 10a of the wafer 10 held on the holding unit 20 with a visible beam that is applied via a focusing optical system 64a above the objective lens casing 62 through the objective lens casing 62 to the wafer 10, and an automatic focusing mechanism 66 for vertically moving the objective lens casing 62 in Z-axis directions, i.e., vertical directions, indicated by an arrow Z to perform focus adjustment on the visible beam. The camera 64 and the automatic focusing mechanism 66 are fixed in a position by fixing means, not illustrated, within the horizontal wall 4b of the frame body 4 and near the lower surface of the distal end portion of the horizontal wall 4b.

As illustrated in FIG. 3, the objective lens casing 62 houses an objective lens assembly 621 therein. According to the illustrated embodiment, the objective lens assembly 621 includes an array of convex lenses, for example. According to the present invention, however, the objective lens assembly 621 is not limited thereto and may include a single convex lens or a combination of convex and concave lenses.

The automatic focusing mechanism 66 includes a stepping motor 66a and an externally threaded rod 66b coupled to the output shaft of the stepping motor 66a. The externally threaded rod 66b is threaded through an internally threaded surface, not illustrated, of a joint 62a fixedly disposed on the objective lens casing 62. When the stepping motor 66a is energized to rotate the externally threaded rod 66b about its central axis in one direction or the other by a command signal from the control unit 100, the objective lens casing 62 that is vertically movably supported below the lower surface of the horizontal wall 4b is vertically moved to a desired position in one of the Z-axis directions.

The control unit 100 is constructed as a computer and includes a central processing unit (CPU) for performing arithmetic processing operations according to control programs, a read only memory (ROM) for storing the control programs, a read/write random access memory (RAM) for temporarily storing image information from the camera 64 and the results of the arithmetic processing operations, etc., an input interface, and an output interface. The details of these components of the control unit 100 are omitted from illustration. The control unit 100 functions as a control unit for controlling the operable components, described above, of the laser processing apparatus 1. In addition, the control unit 100 includes a differential processor 102 for recording an image captured by the camera 64 and performing a differential operation on the image and an automatic focusing controller 104 for issuing a command signal for controlling the automatic focusing mechanism 66.

The illuminating apparatus 70 is mounted on the image capturing apparatus 50 according to the present embodiment. The illuminating apparatus 70 includes an optical fiber 72 and a light source 74. The optical fiber 72 has an end 72a inserted in a minute hole 621b defined centrally in a convex lens 621a that is one of the lenses of the objective lens assembly 621 that is located in the lowermost position and faces the wafer 10 held under suction on the chuck table 25. The optical fiber 72 has another end 72b optically coupled to the light source 74, so that light emitted from the light source 74 can be introduced into the optical fiber 72 from the end 72b. The diameter of the optical fiber 72 and the diameter of the minute hole 621b in the convex lens 621a should preferably be as small as possible. Specifically, the diameter of the optical fiber 72 is of approximately 50 μm, for example, and the diameter of the minute hole 621b is slightly larger than the diameter of the optical fiber 72 and ranges from approximately 51 to 53 μm, for example. The light source 74 may be selected from a variety of light sources including, for example, an SLD light source, an ASE light source, a super continuum light source, an LED light source, a halogen light source, a xenon light source, a mercury light source, a metal halide light source, and a laser light source.

The laser processing apparatus 1 that includes the image capturing apparatus 50 on which the illuminating apparatus 70 according to the present embodiment is mounted is generally constructed as described above. Operation of the laser processing apparatus 1 will be described below. For processing the wafer 10 with a laser beam, the wafer 10 held on the holding unit 20 is moved by the moving mechanism 30 to a position directly below the image capturing unit 60, as illustrated in FIG. 2. After the wafer 10 has been positioned directly below the objective lens casing 62 of the image capturing unit 60, an alignment step is carried out to detect a region of the wafer 10, i.e., one of the projected dicing lines 14, where the face side 10a of the wafer 10 is to be imaged and processed.

For carrying out the alignment step, the light source 74 is energized. When the light source 74 is energized, it emits light L that is introduced into the optical fiber 72 from the end 72b thereof and travels through the optical fiber 72 to the end 72a thereof. Since the end 72a of the optical fiber 72 is inserted in the minute hole 621b defined centrally in the convex lens 621a that is one of the lenses of the objective lens assembly 621 that is located in the lowermost position and faces the wafer 10, the end 72a of the optical fiber 72 acts as a point light source. The light L then spreads conically from the end 72a of the optical fiber 72 in the center of the convex lens 621a and is applied to the face side 10a of the wafer 10.

While the light L is being applied to the face side 10a of the wafer 10, image information obtained by capturing an image by the camera 64 of the image capturing unit 60 is sent to the control unit 100. The automatic focusing controller 104 of the control unit 100 energizes the stepping motor 66a of the automatic focusing mechanism 66, vertically moving the objective lens casing 62 at predetermined pitches. Images of the face side 10a of the wafer 10 that are captured by the camera 64 at the predetermined pitches are stored in the RAM of the control unit 100. The differential processor 102 of the control unit 100 performs differential operations to calculate differential values of sampled points that are included in the captured regions of the images stored in the RAM at the respective predetermined pitches. By determining the differential values of the images captured at the respective predetermined pitches, the differential processor 102 decides that the position corresponding to the image with the largest differential value represents a just focused position. The automatic focusing controller 104 actuates the automatic focusing mechanism 66 to position the objective lens assembly 621 in the just focused position.

Inasmuch as the objective lens assembly 621 is placed in the just focused position thus decided, the camera 64 can capture a clear image of the face side 10a of the wafer 10. Therefore, a region, i.e., one of the projected dicing lines 14, to be processed on the face side 10a of the wafer 10 is accurately detected, and its position is stored in the RAM of the control unit 100, whereupon the alignment step is completed. According to the present embodiment, since the conically shaped light L is applied to the face side 10a of the wafer 10 from the end 72a, as the point light source, of the optical fiber 72 that is disposed in the minute hole 621b defined centrally in the convex lens 621a that faces the wafer 10, no light is overlapped in the captured region and image contrast in the captured image is sharp, thereby eliminating the difficulty in achieving a just focused position.

After the alignment step has been carried out and the position of the projected dicing line 14 to be processed has been detected and stored in the RAM of the control unit 100, the control unit 100 actuates the moving mechanism 30 to position the holding unit 20 directly below the beam condenser 42 of the laser beam applying unit 40. Then, the laser beam applying unit 40 applies a laser beam to the wafer 10 to process the wafer 10 along the projected dicing line 14 with the laser beam on the basis of the positional information of the projected dicing line 14 that is stored in the RAM of the control unit 100.

In the above embodiment, the illuminating apparatus 70 is mounted on the image capturing apparatus 50 of the laser processing apparatus 1. However, the present invention is not limited to the illustrated illuminating apparatus 70. For example, the present invention is also applicable to an illuminating apparatus mounted on an image capturing apparatus of a dicing apparatus for cutting a workpiece with a cutting blade, for example.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. An illuminating apparatus adapted to be mounted on an image capturing apparatus for capturing an image of a workpiece held on a chuck table, comprising:
a light source;
an objective lens having a minute hole defined centrally therein and disposed in facing relation to the workpiece held on the chuck table; and
an optical fiber having an end inserted in the minute hole in the objective lens and another end optically coupled to the light source.

2. The illuminating apparatus according to claim 1, wherein
the light source is selected from a group consisting of a superluminescent diode light source, an amplified spontaneous emission light source, a super continuum light source, a light emitting diode light source, a halogen light source, a xenon light source, a mercury light source, a metal halide light source, and a laser light source.
